(19) United States
(12) Patent Application Publication
(10) Pub. No.: US 2025/0008998 A1
(43) Pub. Date: Jan. 9, 2025

(54) OIL-AND-FAT FEEL ENHANCER AND METHOD FOR ENHANCING OIL-AND-FAT FEEL

(71) Applicant: AJINOMOTO CO., INC., Tokyo (JP)

(72) Inventors: Takaho TAJIMA, Kawasaki-shi (JP); Kazuhiro SAKAMOTO, Kawasaki-shi (JP); Seiji KITAJIMA, Kawasaki-shi (JP)

(73) Assignee: AJINOMOTO CO., INC., Tokyo (JP)

(21) Appl. No.: 18/891,888

(22) Filed: Sep. 20, 2024

Related U.S. Application Data
(63) Continuation of application No. PCT/JP2023/011138, filed on Mar. 22, 2023.

(30) Foreign Application Priority Data
Mar. 23, 2022 (JP) 2022-047015

(51) Int. Cl. A23L 27/00; A23F 5/46; A23L 23/00; A23L 27/20; A23L 27/21; A23L 27/40

(52) U.S. Cl. CPC A23L 27/88; A23F 5/465; A23L 23/00; A23L 27/2028; A23L 27/21; A23L 27/45

(57) ABSTRACT

An oil-and-fat feel enhancer containing at least one selected from potassium salts, calcium salts, and arginines is effective for enhancing an oil-and-fat feel of a food.

### CROSS REFERENCES TO RELATED APPLICATIONS

This application is a continuation of International Patent Application No. PCT/JP2023/011138, filed on Mar. 22, 2023, and claims priority to Japanese Patent Application No. 2022-047015, filed on Mar. 23, 2022, both of which are incorporated herein by reference in their entireties.

### BACKGROUND OF THE INVENTION

### Field of the Invention

The present invention relates to oil-and-fat feel enhancers for enhancing the oil-and-fat feel of food and methods for enhancing the oil-and-fat feel of food.

### Discussion of the Background

In recent years, many foods have been developed in response to the increasing demand from consumers for reducing oil and fat in foods (reduced fat), but the sense of oil (oil-and-fat feel) lost by reducing the oil and fat in foods has been pointed out. Here, the phrase “oil-and-fat feel” refers to the sense lost by reducing the oil and fat in foods and is a comprehensive sense including oil-like richness, thickness, density, creaminess, milkiness, lardiness, mouth coating, mouth watering, and the like.

In response to the above-mentioned points, for example, JP 2021-78395 A, which is incorporated herein by reference in its entirety, discloses a solid oil substitute composition containing a thermocoagulable β-1,3-glucan, oil and fat, and a calcium salt for enhancing the oil-and-fat feel. JP H09-506266 A, which is incorporated herein by reference in its entirety, discloses an artificial flavoring composition containing an amino acid such as arginine for imparting creaminess to foods. Furthermore, JP 2011-72290 A, which is incorporated herein by reference in its entirety, discloses a milk flavor enhancer for enhancing a milk flavor, which is obtained by heating an aqueous solution containing amino acids, whose main components are at least three selected from valine, proline, isoleucine, lysine, glutamic acid, and arginine, and carbohydrates.

### SUMMARY OF THE INVENTION

However, the above-mentioned prior art does not sufficiently enhance the oil-and-fat feel, and techniques and materials that can supplement the oil-and-fat feel are still demanded. Therefore, it is an object of the present invention to provide an oil-and-fat feel enhancer for enhancing the oil-and-fat feel of foods and a method for enhancing the oil-and-fat feel of foods.

These and other object, which will become apparent during the following detailed description, have been achieved by the present inventors' discovery that a good oil-and-fat feel enhancing effect can be obtained by adding an oil-and-fat feel enhancer containing at least one selected from potassium salts, calcium salts, and arginines to foods, and completed the present invention.

That is, the present invention is characterized by the following.

(1) An oil-and-fat feel enhancer comprising at least one selected from potassium salts, calcium salts, and arginines.

(2) The oil-and-fat feel enhancer of (1), comprising two or more selected from potassium salts, calcium salts, and arginines.

(3) The oil-and-fat feel enhancer of (1), comprising potassium salts, calcium salts, and arginines.

(4) The oil-and-fat feel enhancer of any one of (1) to (3), wherein the potassium salt is at least one selected from potassium chloride and dipotassium hydrogen phosphate.

(5) The oil-and-fat feel enhancer of any one of (1) to (4), wherein the calcium salt is at least one selected from calcium lactate, calcium citrate, and calcium chloride.

(6) The oil-and-fat feel enhancer of any one of (1) to (5), wherein the arginines are arginine.

(7) A method for enhancing an oil-and-fat feel of a food, comprising adding the oil-and-fat feel enhancer of any one of (1) to (6) to the food.

(8) The method of (7), wherein an amount of the oil-and-fat feel enhancer added with respect to the potassium salt is an amount such that the concentration of the potassium salt in the food is 10 to 1000 ppm by weight.

(9) The method of (7) or (8), wherein the amount of the oil-and-fat feel enhancer added with respect to the calcium salt is an amount such that the concentration of the calcium salt in the food is 10 to 1000 ppm by weight.

(10) The method of any one of (6) to (9), wherein an amount of the oil-and-fat feel enhancer added with respect to the arginines is an amount such that the concentration of the arginines in the food is 1 to 1000 ppm by weight.

(11) A method for producing a food with an enhanced oil-and-fat feel, comprising adding the oil-and-fat feel enhancer of any one of (1) to (6) to the food.

(12) The production method of (11), wherein an amount of the oil-and-fat feel enhancer added with respect to the potassium salt is an amount such that the concentration of the potassium salt in the food is 10 to 1000 ppm by weight.

(13) The production method of (11) or (12), wherein the amount of the oil-and-fat feel enhancer added with respect to the calcium salt is an amount such that the concentration of the calcium salt in the food is 10 to 1000 ppm by weight. (14) The production method of any one of (11) to (13), wherein an amount of the oil-and-fat feel enhancer added with respect to the arginines is an amount such that the concentration of the arginines in the food is 1 to 1000 ppm by weight.

### Advantageous Effects of Invention

According to the present invention, an oil-and-fat feel enhancer and an oil-and-fat feel enhancing method that can enhance the oil-and-fat feel of foods can be provided.

### DETAILED DESCRIPTION OF THE PREFERRED EMBODIMENTS

In the present specification, the phrase “enhancing an oil-and-fat feel” refers to a concept that includes further improving the oil-and-fat feel of foods and raising a reduced oil-and-fat feel to a normal oil-and-fat feel or even higher, compared to when the oil-and-fat feel enhancer or the oil-and-fat feel enhancing method of the present invention is not applied. For example, the oil-and-fat feel is defined as being enhanced when the oil-and-fat feel enhancer or the oil-and-fat feel enhancing method of the present invention is applied to a food containing a normal amount of oil and fat and the oil-and-fat feel is improved, or when the oil-and-fat feel enhancer or the oil-and-fat feel enhancing method of the present invention is applied to a food containing half the normal amount of oil and fat and the oil-and-fat feel is equal to or greater than that of a food containing the entire normal amount of oil and fat.

### Oil-and-Fat Feel Enhancer

The oil-and-fat feel enhancer of the present invention contains at least one selected from potassium salt, calcium salt, and arginines. That is, the oil-and-fat feel enhancer of the present invention is an oil-and-fat feel enhancer containing potassium salt, an oil-and-fat feel enhancer containing calcium salt, an oil-and-fat feel enhancer containing arginines, an oil-and-fat feel enhancer containing potassium salt and calcium salt, an oil-and-fat feel enhancer containing potassium salt and arginines, an oil-and-fat feel enhancer containing calcium salt and arginines, or an oil-and-fat feel enhancer containing potassium salt, calcium salt, and arginines. The oil-and-fat feel enhancer of the present invention can obtain a synergistic oil-and-fat feel enhancing effect by combining two or more selected from potassium salt, calcium salt, and arginines. In the present specification, “synergistic” means that the score of the oil-and-fat feel enhancing effect by the combination of two or more components is higher than the sum of the scores of the oil-and-fat feel enhancing effect by each component alone in the sensory evaluation method in the following examples, and it is described that a “synergistic” oil-and-fat feel enhancing effect has been obtained.

In one embodiment of the present invention, the oil-and-fat feel enhancer of the present invention is an oil-and-fat feel enhancer containing a potassium salt, an oil-and-fat feel enhancer containing a potassium salt and a calcium salt, an oil-and-fat feel enhancer containing a potassium salt and an arginine, or an oil-and-fat feel enhancer containing a potassium salt, a calcium salt, and an arginine. In another embodiment of the present invention, the oil-and-fat feel enhancer of the present invention is an oil-and-fat feel enhancer containing a calcium salt, an oil-and-fat feel enhancer containing an arginine, or an oil-and-fat feel enhancer containing a calcium salt and an arginine.

The potassium salt is not particularly limited as long as it exerts the effect of the present invention, and examples thereof include potassium chloride, dipotassium hydrogen phosphate, monopotassium citrate, tripotassium citrate, potassium glutamate, potassium hydrogen tartrate, and potassium gluconate. Among these, potassium chloride and dipotassium hydrogen phosphate are preferred from the viewpoint of the high oil-and-fat feel enhancing effect. Only one type of potassium salt may be used, or two or more types thereof may be used in combination.

The calcium salt is not particularly limited as long as the effect of the present invention is exhibited, and examples thereof include calcium lactate, calcium citrate, calcium chloride, calcium glutamate, and calcium ribonucleotide. Among these, calcium lactate, calcium citrate, and calcium chloride are preferred from the viewpoint of the high oil-and-fat feel enhancing effect. Only one type of calcium salt may be used, or two or more types thereof may be used in combination. The arginines are not particularly limited as long as the effect of the present invention is exhibited, and examples thereof include arginine and arginine salts (e.g., arginine hydrochloride, arginine glutamate, etc.). The arginines may be in any of the D-, L-, and DL-forms. Among these, arginine is preferred from the viewpoint of the high oil-and-fat feel enhancing effect, and L-arginine is more preferred. Only one type of arginines may be used, or two or more types thereof may be used in combination.

When the oil-and-fat feel enhancer of the present invention contains a potassium salt and a calcium salt, the weight ratio of the potassium salt to the calcium salt is not particularly limited. It is preferably 1:0.0001 to 10000, more preferably 1:0.0002 to 8000, further preferably 1:0.0005 to 5000.

When the oil-and-fat feel enhancer of the present invention contains a potassium salt and an arginine, the weight ratio of the potassium salt to the arginine is not particularly limited. It is preferably 1:0.0001 to 10000, more preferably 1:0.0002 to 8000, further preferably 1:0.0005 to 5000.

When the oil-and-fat feel enhancer of the present invention contains a calcium salt and an arginine, the weight ratio of the calcium salt to the arginine is not particularly limited. It is preferably 1:0.0001 to 10000, more preferably 1:0.0002 to 8000, further preferably 1:0.0005- to 000.

When the oil-and-fat feel enhancer of the present invention contains a potassium salt, a calcium salt, and an arginine, the weight ratio of the potassium salt to the calcium salt to the arginine is not particularly limited. It is preferably 1:0.0001 to 10000:0.0001 to 10000, more preferably 1:0.0002 to 8000:0.0002 to 8000, further preferably 1:0.0005 to 5000:0.0005-5000.

In a preferred embodiment of the present invention, the oil-and-fat feel enhancer of the present invention contains potassium salt, calcium salt, and arginines. In a more preferred embodiment of the present invention, the oil-and-fat feel enhancer of the present invention contains potassium chloride, calcium lactate, and L-arginine. An oil-and-fat feel enhancer containing potassium chloride, calcium lactate, and L-arginine is particularly useful commercially in terms of the strength of the oil-and-fat feel enhancing effect, food labeling, low raw material costs, and the like.

In addition to potassium salt, calcium salt, and arginines, the oil-and-fat feel enhancer of the present invention may contain any component and seasoning known in the art within a range that does not impair the effects of the present invention. Examples of such components and seasonings include excipients, pH adjusters, antioxidants, thickening stabilizers, sweeteners (e.g., sugars, etc.), acidulants, spices, colorants, and the like.

The oil-and-fat feel enhancer of the present invention can be prepared, for example, by mixing the above-mentioned components in a predetermined weight ratio.

### Method for Enhancing Oil-and-Fat Feel

The method for enhancing oil-and-fat feel of the present invention includes adding the above-mentioned oil-and-fat feel enhancer to food. The food is not particularly limited as long as it is a food for which an enhancement of the oil-and-fat feel is desired (requiring enhancement), and examples thereof include foods containing fats and oils such as oils and fats (e.g., vegetable oils and fats, animal oils and fats, etc.), mayonnaise, soup (e.g., pork soup, ramen soup, consommé soup, chicken soup, etc.), dressing, curry, wrapped foods (e.g., gyoza, shumai, wonton, baozi, xiaolongbao, ravioli, spring rolls, etc.), cooked rice (e.g., fried rice, paella, pilaf, etc.), fried foods (e.g., croquettes, minced meat cutlets, etc.), hamburger steaks, meatballs, sausages, snacks, chocolate, cookies, bread, milk and dairy products containing oils and fats (e.g., cafe au lait, raw milk, cow's milk, low-fat milk, cream, butter, margarine, fat spread, cheese, yogurt, etc.), gratin, beverages containing oil and fat, noodles containing oil and fat (e.g., fried noodles, somen noodles containing oil and fat, etc.); and foods not containing fats and oils such as non-oil dressings, milk and dairy products not containing oil and fat (e.g., non-fat milk, skim milk powder, non-fat yogurt, etc.), beverages not containing oil and fat (e.g., coffee beverages, etc.), noodles not containing oil and fat (e.g., udon, soba, somen noodles not containing oil and fat, non-fried noodles, raw noodles, pasta, noodle strips, frozen noodles, etc.). The oil-and-fat-containing food may contain only oil and fat, that is, the oil-and-fat-containing food may be oil and fat itself. The method of enhancing oil-and-fat feel of the present invention, which includes adding the oil-and-fat feel enhancer to food, also includes an embodiment in which each component of the oil-and-fat feel enhancer (potassium salt, calcium salt, arginines) is added to the food individually (for example, adding each component to the food simultaneously, adding each component to the food in any order, etc.).

The amount of oil-and-fat feel enhancer added is an amount for potassium salt that results in a potassium salt concentration in the food of preferably 10 to 1000 ppm, more preferably 20 to 800 ppm, further preferably 50 to 500 ppm by weight. When the potassium salt concentration is lower than 10 ppm, a sufficient oil-and-fat feel enhancing effect cannot be obtained, while when it is higher than 1000 ppm, an unpleasant taste such as bitterness is imparted.

Furthermore, the amount of the oil-and-fat feel enhancer added is, with respect to calcium salt, such that the concentration of calcium salt in the food is, by weight, preferably 10 to 1000 ppm, more preferably 20 to 800 ppm, further preferably 50 to 500 ppm. When the concentration of calcium salt is lower than 10 ppm, a sufficient oil-and-fat feel enhancing effect is not obtained, while when it is higher than 1000 ppm, an unpleasant taste such as bitterness is imparted.

Furthermore, the amount of the oil-and-fat feel enhancer added is, with respect to arginines, such that the concentration of arginines in the food is, by weight, preferably 1 to 1000 ppm, more preferably 2 to 800 ppm, further preferably 5 to 500 ppm. When the concentration of arginines is lower than 1 ppm, a sufficient oil-and-fat feel enhancing effect is not obtained, while when it is higher than 1000 ppm, an unpleasant taste such as bitterness is imparted.

In one embodiment of the present invention, when the oil-and-fat feel enhancer contains a potassium salt and a calcium salt, the lower limit of the concentration of the potassium salt and the calcium salt in the food may be lower than the above value, taking into consideration that a synergistic effect of enhancing the oil-and-fat feel is obtained by the combination of these components. For example, the amount of addition is such that the concentration of the potassium salt in the food is preferably 1 to 1000 ppm, more preferably 2 to 800 ppm, further preferably 5 to 500 ppm by weight, with respect to potassium salt, and the concentration of the calcium salt in the food is, by weight, preferably 1 to 1000 ppm, more preferably 2 to 800 ppm, further preferably 5 to 500 ppm, with respect to calcium salt.

In another embodiment of the present invention, when the oil-and-fat feel enhancer contains a potassium salt and an arginine, the lower limit of the concentration of the potassium salt and the arginine in the food may be lower than the above value, taking into consideration that a synergistic effect of enhancing the oil-and-fat feel is obtained by the combination of these components. For example, the amount of addition is such that, with respect to potassium salt, the concentration of potassium salt in the food is, by weight, preferably 1 to 1000 ppm, more preferably 2 to 800 ppm, further preferably 5 to 500 ppm, and with respect to arginines, the concentration of arginines in the food is, by weight, preferably 0.1 to 1000 ppm, more preferably 0.2 to 800 ppm, further preferably 0.5 to 500 ppm.

In yet another embodiment of the present invention, when the oil-and-fat feel enhancer contains a calcium salt and an arginine, the lower limit of the concentration of the calcium salt and the arginine in the food may be lower than the above-mentioned value, taking into consideration the synergistic effect of enhancing the oil-and-fat feel due to the combination of these components. For example, the amount of addition is such that, with respect to calcium salt, the concentration of calcium salt in the food is, by weight, preferably 1 to 1000 ppm, more preferably 2 to 800 ppm, further preferably 5 to 500 ppm, and with respect to arginines, the concentration of arginines in the food is, by weight, preferably 0.1 to 1000 ppm, more preferably 0.2 to 800 ppm, further preferably 0.5 to 500 ppm.

In yet another embodiment of the present invention, when the oil-and-fat feel enhancer contains a potassium salt, a calcium salt, and arginines, the lower limit of the concentrations of the potassium salt, calcium salt, and arginines in the food may be lower than the above values, taking into consideration the synergistic effect of enhancing the oil-and-fat feel obtained by the combination of these components. For example, the amount of addition is such that, with respect to potassium salts, the concentration of potassium salt in the food is, by weight, preferably 1 to 1000 ppm, more preferably 2 to 800 ppm, further preferably 5 to 500 ppm; with respect to calcium salts, the concentration of calcium salt in the food is, by weight, preferably 1 to 1000 ppm, more preferably 2 to 800 ppm, further preferably 5 to 500 ppm; and with respect to arginines, the concentration of arginines in the food is, by weight, preferably 0.1 to 1000 ppm, more preferably 0.2 to 800 ppm, further preferably 0.5 to 500 ppm.

In a preferred embodiment of the present invention, the method for enhancing the oil-and-fat feel of the present invention includes adding an oil-and-fat feel enhancer containing a potassium salt, a calcium salt, and arginines to a food. In a more preferred embodiment of the present invention, the method for enhancing the oil-and-fat feel of the present invention includes adding an oil-and-fat feel enhancer containing potassium chloride, calcium lactate, and L-arginine to a food. The method for enhancing oil-and-fat feel of the present invention which includes adding an oil-and-fat feel enhancer containing potassium chloride, calcium lactate, and L-arginine to a food is particularly useful commercially in terms of the strength of the oil-and-fat feel enhancing effect, food labeling, low raw material costs, and the like.

### Method for Producing Food with Enhanced Oil-and-Fat Feel

The present invention also relates to a method for producing food with enhanced oil-and-fat feel. The method for producing food with enhanced oil-and-fat feel of the present invention includes adding the above-mentioned oil-and-fat feel enhancer to a food. The food is not particularly limited as long as it is a food for which an enhancement of the oil-and-fat feel is desired (requiring enhancement), and examples thereof include the foods listed in the description of the above-mentioned Method for enhancing oil-and-fat feel. In the method for producing a food with an enhanced oil-and-fat feel of the present invention, adding the oil-and-fat feel enhancer to a food also includes adding each component of the oil-and-fat feel enhancer (potassium salt, calcium salt, arginines) to the food individually (for example, adding each component to the food simultaneously, adding each component to the food in any order, and the like).

The amount of the oil-and-fat feel enhancer to be added can be appropriately determined by referring to the amount added in the above-mentioned Method for enhancing oil-and-fat feel, whether each component (potassium salt, calcium salt, arginines) is used alone or in combination.

In a preferred embodiment of the present invention, the method for producing a food with an enhanced oil-and-fat feel of the present invention includes adding an oil-and-fat feel enhancer containing a potassium salt, a calcium salt, and arginines to a food. In a more preferred embodiment of the present invention, the method for producing a food with an enhanced oil-and-fat feel of the present invention includes adding an oil-and-fat feel enhancer containing potassium chloride, calcium lactate, and L-arginine to a food. A method for producing a food with enhanced oil-and-fat feel, including adding an oil-and-fat feel enhancer containing potassium chloride, calcium lactate, and L-arginine to a food, is particularly useful commercially from the standpoints of the strength of the oil-and-fat feel enhancing effect, food labeling, low raw material costs, and the like.

Other features of the invention will become apparent in the course of the following descriptions of exemplary embodiments which are given for illustration of the invention and are not intended to be limiting thereof.

### EXAMPLES

### Sensory Evaluation Method

Sensory evaluation was performed on the strength of the oil-and-fat feel and the presence or absence of an off-flavor of the test samples. The oil-and-fat feel was evaluated by a panel of three experts who ate the positive control (PC), negative control (NC), and test samples (test plots 1-32 for Example 1; test plots 1-19 for Example 2; test plots 1-7 for Example 3), scored the test samples in 0.0 to 10.0 points in increments of 0.1 point, with PC being 10.0 points and NC being 1.0 point (non-blind), and then averaged the scores obtained by the three experts. The evaluation of off-flavors was performed by a panel of three experts who tasted the test samples and judged by consensus (non-blind) whether off-flavors (tastes and aromas (e.g., chemical odors) not present in NC or PC) were present.

### Example 1

Pork soup (2.5% by weight pork powder, 0.3% by weight salt, 97.2% by weight hot water) was used as the NC, and pork soup (2.5% by weight pork powder, 0.3% by weight salt, 1% by weight lard, 96.2% by weight hot water) was used as the PC. The test samples were prepared by adding each component (potassium chloride, calcium lactate, L-arginine) to the pork soup (NC) so that the concentration of each component in the pork soup (NC) was the value shown in Table 1. The obtained test samples were evaluated according to the sensory evaluation method described above. The results are shown in Table 1.

TABLE 1

| | | potassium | calcium | L- | strength | |
|---|---|---|---|---|---|---|
| | | chloride | lactate | arginine | of oil- | |
| component | | conc. | con. | con. | and-fat | off- |
| number | test plot | (ppm) | (ppm) | (ppm) | feel | flavor |
| PC | | 0 | 0 | 0 | 10.0 | none |
| NC | | 0 | 0 | 0 | 1.0 | none |
| single | test plot 1 | 1 | 0 | 0 | 1.8 | none |
| component | test plot 2 | 10 | 0 | 0 | 2.2 | none |
| | test plot 3 | 100 | 0 | 0 | 2.6 | none |
| | test plot 4 | 165 | 0 | 0 | 2.9 | none |
| | test plot 5 | 500 | 0 | 0 | 3.5 | none |
| | test plot 6 | 1000 | 0 | 0 | 4.0 | none |
| | test plot 7 | 0 | 1 | 0 | 1.7 | none |
| | test plot 8 | 0 | 10 | 0 | 2.2 | none |
| | test plot 9 | 0 | 100 | 0 | 2.7 | none |
| | test plot 10 | 0 | 240 | 0 | 3.1 | none |
| | test plot 11 | 0 | 500 | 0 | 3.6 | none |
| | test plot 12 | 0 | 1000 | 0 | 4.2 | none |
| | test plot 13 | 0 | 0 | 1 | 1.5 | none |
| | test plot 14 | 0 | 0 | 10 | 1.6 | none |
| | test plot 15 | 0 | 0 | 12 | 1.9 | none |
| | test plot 16 | 0 | 0 | 100 | 2.4 | none |
| | test plot 17 | 0 | 0 | 500 | 2.7 | none |
| | test plot 18 | 0 | 0 | 1000 | 2.7 | none |
| 2 | test plot 20 | 10 | 10 | 0 | 3.9 | none |
| components | test plot 21 | 10 | 100 | 0 | 4.4 | none |
| | test plot 22 | 10 | 0 | 1 | 3.4 | none |
| | test plot 23 | 10 | 0 | 10 | 3.6 | none |
| | test plot 24 | 0 | 10 | 1 | 3.3 | none |
| | test plot 25 | 0 | 10 | 10 | 3.5 | none |
| | test plot 26 | 0 | 100 | 1 | 3.7 | none |
| | test plot 27 | 0 | 100 | 10 | 3.9 | none |
| 3 | test plot 29 | 10 | 10 | 1 | 5.6 | none |
| components | test plot 30 | 10 | 10 | 100 | 5.9 | none |
| | test plot 31 | 10 | 100 | 1 | 6.1 | none |
| | test plot 32 | 10 | 100 | 10 | 6.5 | none |

### Example 2

Pork soup (pork powder 2.5 by weight, salt 0.3 by weight, hot water 97.2% by weight) was used as NC, and pork soup (pork powder 2.5% by weight, salt 0.3% by weight, lard 18 by weight, hot water 96.2% by weight) was used as PC. Test samples were prepared by adding each component (potassium salt, calcium salt, arginines) to pork soup (NC) such that the concentrations of each component in the pork soup (NC) were 10 ppm, 10 ppm, and 1 ppm, respectively. The obtained test samples were evaluated according to the sensory evaluation method described above. The results are shown in Table 2.

TABLE 2

| | | | | type of | strength | |
|---|---|---|---|---|---|---|
| | | type of | type of | arginines | of oil- | |
| component | | potassium salt | calcium salt | (1 ppm | and-fat | off- |
| number | test plot | (10 ppm addition) | (10 ppm addition) | addition) | feel | flavor |
| PC | | — | — | — | 10.0 | none |
| NC | | — | — | — | 1.0 | none |
| 1 | test plot 1 | potassium chloride | — | — | 2.2 | none |
| component | test plot 2 | dipotassium hydrogen | — | — | 2.2 | none |
| | | phosphate | | | | |
| | test plot 3 | — | calcium lactate | — | 2.2 | none |
| | test plot 4 | — | calcium chloride | — | 2.4 | none |
| | test plot 5 | — | calcium citrate | — | 2.1 | none |
| | test plot 6 | — | — | L- | 1.5 | none |
| | | | | arginine | | |
| 2 | test plot 7 | potassium chloride | calcium chloride | — | 4.3 | none |
| components | test plot 8 | potassium chloride | calcium citrate | — | 4.2 | none |
| | test plot 9 | dipotassium hydrogen | calcium lactate | — | 4.2 | none |
| | | phosphate | | | | |
| | test plot 10 | dipotassium hydrogen | calcium chloride | — | 4.4 | none |
| | | phosphate | | | | |
| | test plot 11 | dipotassium hydrogen | calcium citrate | — | 4.2 | none |
| | | phosphate | | | | |
| | test plot 12 | dipotassium hydrogen | — | L- | 3.5 | none |
| | | phosphate | | arginine | | |
| | test plot 13 | — | calcium chloride | L- | 3.7 | none |
| | | | | arginine | | |
| | test plot 14 | — | calcium citrate | L- | 3.6 | none |
| | | | | arginine | | |
| 3 | test plot 15 | potassium chloride | calcium chloride | L- | 6.2 | none |
| components | | | | arginine | | |
| | test plot 16 | potassium chloride | calcium citrate | L- | 5.9 | none |
| | | | | arginine | | |
| | test plot 17 | dipotassium hydrogen | calcium lactate | L- | 6.1 | none |
| | | phosphate | | arginine | | |
| | test plot 18 | dipotassium hydrogen | calcium chloride | L- | 6.1 | none |
| | | phosphate | | arginine | | |
| | test plot 19 | dipotassium hydrogen | calcium citrate | L- | 5.8 | none |
| | | phosphate | | arginine | | |

### Example 3

Low-fat cafe au lait (97.8% low-fat milk, 1.5% granulated sugar, 0.7% instant coffee) was used as the NC, and high-fat cafe au lait (97.8% high-fat milk, 1.5% granulated sugar, 0.7% instant coffee) was used as the positive control (PC). Test samples were prepared by adding each component (potassium chloride, calcium lactate, L-arginine) to low-fat cafe au lait (NC) such that the concentration of each component in the low-fat cafe au lait (NC) was the value shown in Table 3. The obtained test samples were evaluated according to the sensory evaluation method described above. The results are shown in Table 3.

TABLE 3

| | | potassium | calcium | L- | strength | |
|---|---|---|---|---|---|---|
| | | chloride | lactate | arginine | of oil- | |
| component | | conc. | conc. | conc. | and-fat | off- |
| number | test plot | (ppm) | (ppm) | (ppm) | feel | flavor |
| PC | | 0 | 0 | 0 | 10.0 | none |
| NC | | 0 | 0 | 0 | 1.0 | none |
| 1 | test plot 1 | 10 | 0 | 0 | 2.1 | none |
| component | test plot 2 | 0 | 10 | 0 | 2.4 | none |
| | test plot 3 | 0 | 0 | 1 | 1.6 | none |
| 2 | test plot 4 | 10 | 10 | 0 | 3.8 | none |
| components | test plot 5 | 10 | 0 | 1 | 3.5 | none |
| | test plot 6 | 0 | 10 | 1 | 3.5 | none |
| 3 | test plot 7 | 10 | 10 | 1 | 5.5 | none |
| components | | | | | | |

From the above results, it is clear that the test sample to which potassium salt/calcium salt/arginines were added had an improved (enhanced) oil-and-fat feel compared to the negative control to which potassium salt/calcium salt/arginines were not added, and also had no off-flavor. Furthermore, it is clear that the test sample to which two or more types of potassium salt/calcium salt/arginines were added in combination showed a synergistic effect of enhancing the oil-and-fat feel.

### Industrial Applicability

The oil-and-fat feel enhancer and the method for enhancing an oil-and-fat feel of the present invention can enhance the oil-and-fat feel of foods.

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. An oil-and-fat feel enhancer comprising at least one selected member selected from the group consisting of a potassium salt, a calcium salt, and an arginine.

2. The oil-and-fat feel enhancer according to claim 1, comprising two or more members selected from the group consisting of a potassium salt, a calcium salt, and an arginine.

3. The oil-and-fat feel enhancer according to claim 1, comprising a potassium salt, a calcium salt, and an arginine.

4. The oil-and-fat feel enhancer according to claim 1, wherein the potassium salt is at least one selected from the group consisting of potassium chloride and dipotassium hydrogen phosphate.

5. The oil-and-fat feel enhancer according to claim 1, wherein the calcium salt is at least one selected from the group consisting of calcium lactate, calcium citrate, and calcium chloride.

6. The oil-and-fat feel enhancer according to claim 1, wherein the arginines are arginine.

7. A method for enhancing an oil-and-fat feel of a food, comprising adding the oil-and-fat feel enhancer according to claim 1 to the food.

8. The method according to claim 7, wherein an amount of the oil-and-fat feel enhancer added with respect to the potassium salt is an amount such that the concentration of the added potassium salt in the food is 10 to 1000 ppm by weight.

9. The method according to claim 7, wherein the amount of the oil-and-fat feel enhancer added with respect to the calcium salt is an amount such that the concentration of the added calcium salt in the food is 10 to 1000 ppm by weight.

10. The method according to claim 7, wherein an amount of the oil-and-fat feel enhancer added with respect to the arginines is an amount such that the concentration of the added arginines in the food is 1 to 1000 ppm by weight.

11. A method for producing a food with an enhanced oil-and-fat feel, comprising adding the oil-and-fat feel enhancer according to claim 1 to the food.

12. The production method according to claim 11, wherein an amount of the oil-and-fat feel enhancer added with respect to the potassium salt is an amount such that the concentration of the added potassium salt in the food is 10 to 1000 ppm by weight.

13. The production method according to claim 11, wherein the amount of the oil-and-fat feel enhancer added with respect to the calcium salt is an amount such that the concentration of the added calcium salt in the food is 10 to 1000 ppm by weight.

14. The production method according to claim 11, wherein an amount of the oil-and-fat feel enhancer added with respect to the arginines is an amount such that the concentration of the added arginines in the food is 1 to 1000 ppm by weight.
